(19) United States
(12) Patent Application Publication
(10) Pub. No.: US 2016/0253155 A1
(43) Pub. Date: Sep. 1, 2016

(54) APPARATUS AND METHOD FOR METAPROGRAMMING PLATFORM

(71) Applicant: The Treeline Company, Austin, TX (US)

(72) Inventors: Mike McNeil, Austin, TX (US); Scott Gress, Austin, TX (US); Cody Stoltman, Austin, TX (US); Rachael Shaw, Austin, TX (US); Irl Nathan, Austin, TX (US)

(21) Appl. No.: 15/054,995

(22) Filed: Feb. 26, 2016

Related U.S. Application Data
(60) Provisional application No. 62/126,243, filed on Feb. 27, 2015.

(51) Int. Cl. G06F 9/44; G06F 11/36

(52) U.S. Cl. CPC G06F 8/34; G06F 8/33; G06F 11/3684; G06F 8/315

(57) ABSTRACT

Provided is a process of compiling user instructions into a JavaScript program, the process including: obtaining a library comprising a plurality of subroutines having a standardized interface and encoded in a human-readable format; obtaining a decision tree, the decision tree containing a declarative representation of business logic to be implemented in a human-readable JavaScript program to be executed server-side in a client-server architecture, the decision tree identifying at least a plurality of the subroutines in the library to be used in the JavaScript program; and compiling the decision tree and the plurality of subroutines into the JavaScript program, wherein compiling comprises: crawling the decision tree and identifying the subroutines; parsing the one or more instructions executed to perform the tasks of the identified subroutines from the respective standardized interface of the identified subroutines; and adding at least part of the parsed instructions to a text representation of the JavaScript program.

### CROSS-REFERENCE TO RELATED APPLICATIONS

The present application is a non-provisional of, and thus claims the benefit of, U.S. Provisional Patent Application 62/126,243, filed 27 Feb. 2015, titled VISUAL WEB DEVELOPMENT FRAMEWORK. The entire content of this parent application is hereby incorporated by reference.

### BACKGROUND

1. Field

The present invention relates generally to software development and, more specifically, to metaprogramming for software development.

2. Description of the Related Art

Programming is too difficult for those not trained as developers. Non-technical business people often struggle to obtain or modify the software they need, and writing the code themselves is often beyond their capabilities. Compounding this problem, developer time is expensive, and software development projects of commercially relevant scope tend to be highly complex. Even when developers are available, validating whether the delivered code meets the business person's requirements is often too difficult. Similar problems arise when existing code needs to be changed.

Visual programming languages exist to assist less technical users. But the languages are often lacking in various regards. For instance, less experienced users often struggle with edge cases of programs, where certain, often unintended, scenarios break the logic that handles more common cases. Similarly, many existing tools place too much of a burden on the user to validate, test, and document their programs.

### SUMMARY

The following is a non-exhaustive listing of some aspects of the present techniques. These and other aspects are described in the following disclosure.

Some aspects include a process of compiling user instructions into a JavaScript program, the process including: obtaining a library comprising a plurality of subroutines having a standardized interface and encoded in a human-readable format; obtaining a decision tree, the decision tree containing a declarative representation of business logic to be implemented in a human-readable JavaScript program to be executed server-side in a client-server architecture, the decision tree identifying at least a plurality of the subroutines in the library to be used in the JavaScript program; and compiling the decision tree and the plurality of subroutines into the JavaScript program, wherein compiling comprises: crawling the decision tree and identifying the subroutines; parsing the one or more instructions executed to perform the tasks of the identified subroutines from the respective standardized interface of the identified subroutines; and adding at least part of the parsed instructions to a text representation of the JavaScript program.

Some aspects include a tangible, non-transitory, machine-readable medium storing instructions that when executed by a data processing apparatus cause the data processing apparatus to perform operations including the above-mentioned process.

Some aspects include a system, including: one or more processors; and memory storing instructions that when executed by the processors cause the processors to effectuate operations of the above-mentioned process.

### BRIEF DESCRIPTION OF THE DRAWINGS

The above-mentioned aspects and other aspects of the present techniques will be better understood when the present application is read in view of the following figures in which like numbers indicate similar or identical elements:

FIG. 1 illustrates an example of a computing environment having a metaprogramming platform consistent with some of the present techniques;

FIG. 2 illustrates a process performed by the platform of FIG. 1;

FIG. 3 illustrates a first screen shot of a graphical user interface of the platform of FIG. 1;

FIG. 4 illustrates a second screen shot of a graphical user interface of the platform of FIG. 1;

FIG. 5 illustrates a third screen shot of a graphical user interface of the platform of FIG. 1; and

FIG. 6 illustrates an example of a computer system by which the above techniques may be implemented.

While the invention is susceptible to various modifications and alternative forms, specific embodiments thereof are shown by way of example in the drawings and will herein be described in detail. The drawings may not be to scale. It should be understood, however, that the drawings and detailed description thereto are not intended to limit the invention to the particular form disclosed, but to the contrary, the intention is to cover all modifications, equivalents, and alternatives falling within the spirit and scope of the present invention as defined by the appended claims.

### DETAILED DESCRIPTION OF CERTAIN EMBODIMENTS

To mitigate the problems described herein, the inventors had to both invent solutions and, in some cases just as importantly, recognize problems overlooked (or not yet foreseen) by others in the field of programming language development. Indeed, the inventors wish to emphasize the difficulty of recognizing those problems that are nascent and will become much more apparent in the future should trends in industry continue as the inventors expect. Further, because multiple problems are addressed, it should be understood that some embodiments are problem-specific, and not all embodiments address every problem with traditional systems described herein or provide every benefit described herein. That said, improvements that solve various permutations of these problems are described below.

Some embodiments use a standardized interface for wrapping subroutines (e.g., functions) to make it easier for non-developers (and less skilled developers) to program. These standardized interfaces allows programs to be composed by expressing the business needs at a higher-level of expression, closer to the way in which a business person would explain functional requirements to a developer. Certain aspects of the standardized interface afford various benefits that improve code quality and flexibility, e.g., validation, type safety checks, and code quality checks may leverage information in the standardized interface to lower the bar to producing well documented, flexible, and reliable code. That said, not all embodiments provide all of these benefits. Several inventions are described, and these inventions are independently useful.

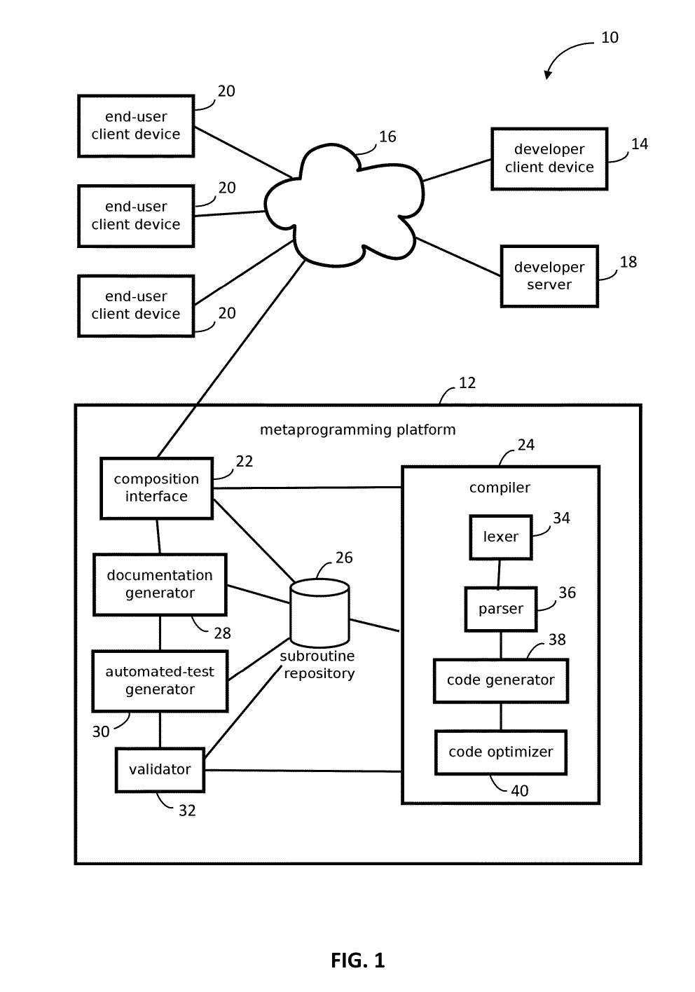

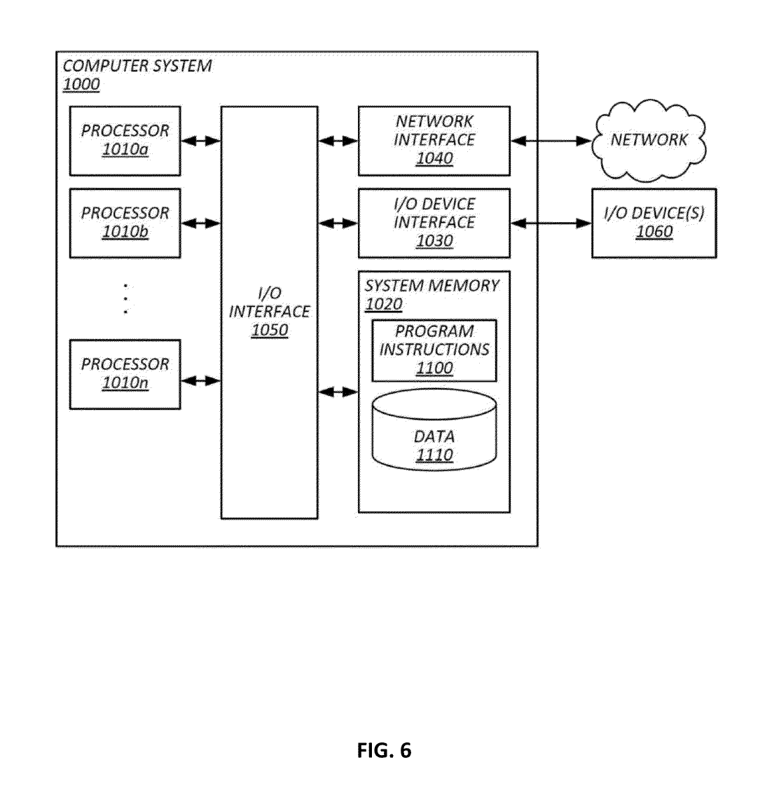

FIG. 1 illustrates an example of a computing environment 10 having a metaprogramming platform 12 that may mitigate some or all of the various issues with traditional techniques discussed above. In some embodiments, the platform 12 may host a library of subroutines having standardized interfaces that facilitate reuse and ease of implementation for relatively unsophisticated software developers. In some embodiments, the platform 12 may host a web-based integrated development environment for composing programs with the subroutines in a graphical user interface on a developer client device 14, which may access the platform 12 via the Internet 16. Upon a developer composing a program, the program may be uploaded to a developer server 18, and the program may execute on the server 18 to service requests from user client devices 20. Examples of computing devices by which these components may be implemented are described below with reference to FIG. 6. In the illustrated embodiment only three end-user devices 20 are illustrated and only one developer client device 14 and one developer server 18 are illustrated, but embodiments are consistent with substantially more instances of such devices. Likely use cases will have, for example, more than 500 concurrent sessions with developer client devices, more than 5,000 developer servers 18 serving more than 1 million and end user client devices with various backend software created with the developer client device 14 cooperating with platform 12.

In some embodiments, the library of subroutines having a standardized interface may have the format exemplified by the following instance of a standardized subroutine:

```
module.exports = {
  friendlyName: ‘Do something’,
  description: ‘Do something with the provided inputs that results in one of the exit scenarios.’,
  extendedDescription: ‘This optional extended description can be used to communicate caveats,
technical notes, or any other sort of additional information which might be helpful for users of
this machine.’,
  moreInfoUrl: ‘https://stripe.com/docs/api#list_cards’,
  cacheable: true,
  sync: true,
  inputs: {
  apiKey: {
    description: ‘The api key to be used.’,
    required: true,
    example: ‘foo’,
    whereToGet: {
    url: ‘https://dashboard.stripe.com/account/apikeys’,
    description: ‘Copy either “Test Secret Key” or “Live Secret Key” from your Stripe
dashboard.’,
    extendedDescription: ‘You will first need to log in to your Stripe account, or create one if
you have not already done so.’
    }
  }
  },
  defaultExit: ‘success’,
  exits: {
  success: {
    example: ‘myApiKey’,
    description: ‘Returns the API key for your totally fake account’,
    variableName: ‘rateLimitMetadata’
  },
  error: {
    description: ‘Unexpected error occurred.’
  }
  },
  fn: function(inputs, exits) {
  // ...
  // your code here
  var result = ‘foo’;
  // ...
  // ...and when you're done:
  return exits.success(result);
  };
}
```

As indicated, in some embodiments, the standardized interface may be expressed in a serialized hierarchical data format, for example extensible markup language (XML) or JavaScript object notation (JSON). Various fields within the standardized interface may supplement and serve as metadata to the code that is executed when performing the subroutine. This metadata may assist less experienced developers with using the subroutines and may be repurposed for various tasks associated with programming, for example, generating tests, checking code quality, and documenting resulting programs. In some embodiments, the executable code of the standardized interface may be encoded in a human readable format, for example, in a scripting language, like JavaScript. Or other languages may be used, popular examples including Python, Java, and PHP. In some embodiments, the subroutines may be composed into larger JavaScript programs executed in a Node.JS server (or other backend service), for instance on developer server 18.

The standardized interface may include a variety of different fields that serve various purposes. Above, the field labeled friendlyName may serve as a display name for the subroutine used in graphical user interfaces by which the developer composes larger programs. In some cases, the display name may have less than a threshold number of characters to facilitate compact displays. The next parameter is labeled description, which may be a relatively short description of the functionality of the subroutine, for example, expressed in the imperative and less than 80 characters. In some embodiments, the graphical user interface may display this slightly longer description in response to a user hovering a pointer over, or selecting, a graphical icon representing the subroutine. The next parameter, labeled extended description, may provide a longer, prose description of the functionality of the subroutine and how it works and various caveats, such as limitations on the types of inputs that it can accept, limitations on the types of outputs it can provide, and various specifications for how the subroutine may be used. Some embodiments may further include a field labeled moreInfoURL that provides a link to a webpage with additional information about the subroutine. In some embodiments, the subroutine metadata in the standardized interface may include a field labeled cacheable, which may indicate whether the a .cache( ) method provided in Node.js can be used with this subroutine. Generally, more experienced developers know that subroutine should not be cached if they have side effects, for instance, fetching a list of tweets which contain a particular hashtag is generally cacheable, while posting a tweet is not, as the latter has a side effect in the form of an emission of the tweet into the world. Providing, automatically enforcing, this value in association with the subroutine is expected to help less experienced developers use the subroutine with fewer errors. (Though, not all embodiments provide this benefit.)

In some embodiments, the standardized interface for a subroutine may include a set of (for example a list or dictionary of) inputs. These may be values (e.g., data structures (e.g., arrays, lists, dictionaries, etc.), functions, strings, integers, or the like) that serve as input parameters to the associated function or subroutine. In some cases, each input may be associated with an input key value (for instance a key in a dictionary) in this example labeled apiKey. Associated with that input key value (or name of the input) is a list of attributes of the particular input. In this example, the input includes a short description of the input to aid developers in supplying proper inputs, for example, by displaying the short description in a graphical user interface where a user drags and drops inputs to the subroutine. A field labeled required may be a binary value that indicates whether the input is required by the subroutine to function properly. In some cases, when compiling, embodiments may perform a code quality check to determine whether an exit, such as an output, of and upstream subroutine will provide an adequate input when required and, in response to detecting a mismatch, alert the developer. Some embodiments may further include an example field by which an example of the type of input is provided to further assist developers with understanding what is expected. Some embodiments may include a parameter labeled whereToGet that provides additional information about how to locate a suitable value for this input. In some cases, this may indicate an application program interface (API) of a third-party from whom the subroutine is designed to ingest data. Similar expansions on the description of this data source may be provided for display in graphical user interfaces. In this example, a single input is specified, but embodiments are expected to include subroutines with various numbers of inputs enumerated, for example, more than two, more than four, or more than five. In some cases, the inputs may be values that are passed (e.g., by value or reference) to the subroutine when the subroutine is called.

Next, in the standardized interface, some embodiments may specify exits of the subroutine. Exits are various ways in which program flow can leave the subroutine. Examples include an exit in which a function returns a value calculated by the function. Other examples include error conditions that may arise in the course of executing the subroutine, such as division by zero, stack overflows, type mismatches, and the like. More experienced developers know to anticipate and handle these various exits to write robust software, but enumerating and specifying these exits in advance in the standardized interface is expected to help less experienced developers prepare robust software. In this example, the exits include a default exit, which indicates the expected outcome of a subroutine, e.g., not an error exit. In some embodiments, the exits may be specified in a data structure similar to that of the inputs, for example, as a dictionary. In this example, the first item in the dictionary has a key value labeled success, which serves as a name of this particular exit. In some embodiments, each exit may include an example field indicating an example of the type of data expected to be returned. Some embodiments may further include a description in prose form of the result of the exit. In some embodiments, an example variable name may be provided for use in automatically generated documentation to explain the exit. In this example, two exits are illustrated, the second being labeled error. Some embodiments are expected to have substantially more exits as various types of results may occur in more complicated subroutines.

Additional fields may be it associated with the various inputs and exits to facilitate additional automated assistance for less experienced developers. Examples include expected datatypes of inputs or exits (which some embodiments may use for automated type checking and alerting when type mismatches occur, like when an exit of one type is linked to an input of another type), expected format of data for inputs or exits (which some embodiments may use for automated data normalization checks and code quality checks), and expected ranges or examples of values paired with expected exits (which some embodiments may use for automated generation of tests for subroutines by applying the expected ranges or examples of values and determining whether the exit matches the expected exit).

Next, some embodiments may include the subroutine for which the standardized interface is provided. In some embodiments, the subroutine may be the code executed when performing the subroutine, in contrast to the rest of the standardized interface, which provides metadata about the subroutine and is not necessarily executed when the subroutine is called. In some embodiments, the instructions may be encoded in a human readable scripting language, for example, in JavaScript. In some embodiments, input parameters listed in the metadata of the standardized interface as inputs may appear in parentheses following the definition of the subroutine. The various exits may either be explicitly or implicitly specified in the body of the subroutine. In some cases, explicit exits may be provided with a try-catch or try-catch-finally error handling block bracketing some or all of the subroutine.

In some embodiments, the standardized interface may be used by the metaprogramming platform 12 to assist less experienced developers with writing backend (e.g. server-side) code in a client/server architecture (e.g. a website or API of a native application of on a mobile device). In some embodiments, the end-user client devices 20 may be the client computing device in this architecture, with some of the end-user client devices being, for example, tablet computers, laptop computers, personal computers, set-top boxes, wearable computing devices, mobile computing devices, in-dash automotive computing devices, and the like.

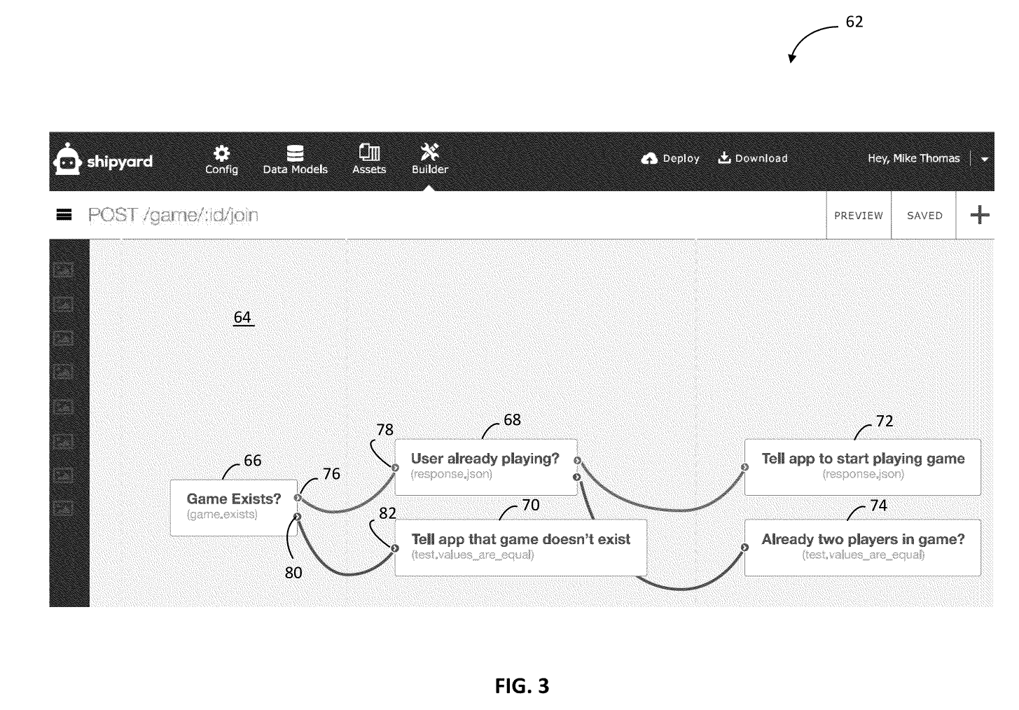

In some embodiments, the metaprogramming platform 12 may provide a graphical user interface integrated development environment for a visual programming language in which a developer operating the developer client device 14 may drag-and-drop various subroutines and connect exits of subroutines to inputs of other subroutines, again by dragging and dropping and without entry via keyboard (though embodiments are also consistent with keyboard entry). Examples of such interfaces that may be sent to the developer device are described below with reference to FIGS. 3 through 5.

In some embodiments, the metaprogramming platform may be operative to, in addition to providing these graphical user interfaces to developers, receive compositions of the subroutines from the developer device and compile those compositions into programs. Compiling, in this context, does not require compiling to machine code or byte code. In some embodiments, the compiled program is a human readable program in scripting language format, for example, in JavaScript, suitable for further manipulation by the developer or a more experienced developer. Subsequent compiling or interpretation steps may be required to translate this result into something that a computer can execute. In some embodiments, the compiled program (and in some cases resources and various dependencies and directory structures) may be downloaded from the platform 12 to the client device 14 for testing and execution on the client device 14. The developer client device 14 may then upload the resulting program and associated resources to the developer server 18, which may then execute the resulting program to service end-user client devices 20.

In this example, the platform 12 includes a composition interface 22, a compiler 24, a subroutine repository 26, a documentation generator 28, an automated-test generator 30, and a validator 32. The illustrated platform 12 is a remotely hosted platform accessible over the Internet 16, but in some embodiments, the platform 12 may be executed locally on the developer client device 14. Or in some embodiments, portions of the platform 12 may be executed locally on the client device 14, for example, the subroutine repository 26 may reside in one or more remotely hosted repositories of subroutines while other components are executed locally.

In some embodiments, the composition interface 22 may provide the graphical integrated development environment described below with reference to FIGS. 3 through 5, by which a developer using the client device 14 may drag-and-drop various subroutines in the repository 26 and drag-and-drop to connect exits from the subroutines to inputs to other subroutines. The composition interface 22 may also provide various input forms by which a user provides values for use in the subroutines. In some embodiments, the composition interface is provided as a web interface rendered in a browser executing on the developer client device 14.

The compiler 24 may be operative to receive a composition of subroutines configured at the developer client device 14 and translate that compilation into a program, for instance, a human readable scripting language program, like a JavaScript program. In some embodiments, the composition may include a collection of the subroutines residing in the repository 26 and used within the program as well as data specifying inputs to the subroutines, for example, either from exits of other subroutines, or third-party APIs or user inputs. In some embodiments, the compilation may be expressed as business logic describing what the program does in a declarative form, rather than requiring the user to specify program flow by which that functionality is implemented, thereby more closely aligning with the way in which less technical people approach software development. In some embodiments, the composition is expressed as a decision tree with nodes of the tree corresponding to the subroutines, and leaf nodes corresponding to subroutines for which there is no exit within the program at issue, for instance, exits to third-party services or exits in which a result is displayed. In some embodiments, the decision tree may have edges indicating which exits mapped to which input of other subroutines, and the tree may branch as the subroutine at a given node determines which exit is appropriate based on the given inputs. This declarative format for describing what a program does is expected to be much more accessible to less skilled developers and facilitate program development, maintenance, and quality checks. It should be noted that decision trees need not be rendered as trees in a visual presentation to the developer to constitute a tree, though one benefit of the tree structure is it yields graphical representations that are readily visually parsed.

In some embodiments, the compiler 24 includes a lexer 34 a parser 36, a code generator 38, and a code optimizer 40. In some embodiments, the lexer 34 may receive the decision tree and classify various sequences of characters encoding the decision tree as corresponding to subroutines in the subroutine repository, links between particular subroutines, and identifiers of inputs or exits corresponding to the subroutines. In some embodiments, the parser may take these classified sequences of characters and convert them into an abstract syntax tree referencing the subroutines and the links (e.g., program calls between the subroutines). Next, the code generator 38 may compose a human readable JavaScript program based on the abstract syntax tree. In some embodiments, the code generator 38 may crawl the tree, identify references to subroutines, retrieve the corresponding subroutine from the repository 26, parse the portion of the subroutine that indicates the instructions executed to perform the functionality of the subroutine from the standardized interface, and add that parsed code to a JavaScript program. In some cases, the code generator 38 may detect also when one program calls another and insert into the JavaScript program a subroutine call to the other referenced subroutine, inserting as parameters in the subroutine call the value specified by the developer, for example, the exit parameters of the calling subroutine that the developer mapped to the inputs for the called subroutine.

Some embodiments may further include a code optimizer 40 that performed various automated steps to improve the run time or memory performance of the resulting code. For example, some embodiments may unroll loops and repeat instances of generated code to cause the code to run faster and reduce jumps performed by a program counter executing the code. In another example, some embodiments may detect when a subroutine queries a database repeatedly and consolidate the queries into a single query, e.g., requesting all user profiles in a single query, rather than iteratively submitting queries for one user profile at a time.

Some embodiments may further include the subroutine repository 26, which may include one or more libraries of subroutines having a standardized interface like that described above. In some embodiments, each of the subroutines may be further associated with versioning information indicating, for example, if a version of the subroutine has changed and providing instructions for migrating between versions.

Some embodiments may further include a documentation generator 28. In some embodiments, the documentation generator 28 may identify subroutines referenced in a produced program. The generator 28 may parse from the standardized interfaces of the subroutines a description of the subroutines and the description of the exits and inputs of the subroutines referenced to generate a prose form description of the resulting program suitable for consumption by users trying to understand the operation of the program. Some embodiments may generate the documentation in the form of a webpage and provide a URL by which the documentation is accessed.

Some embodiments may further include an automated test generator 30, which may generate tests for the program based on information in the standardized interface of the reference to subroutines. For example, as noted above, in some embodiments, the standardized interfaces may include pairs of inputs and expected outputs for the subroutine, and some embodiments may automatically generate code that applies those inputs and compares the result to the expected outputs to determine whether the subroutine is executing properly. Some embodiments may perform these tests and generate reports for users.

Some embodiments may also include a validator 32 operative to validate whether inputs to subroutines are in the proper format, of the proper type, and are normalized in the proper fashion. In some embodiments, the validator may generate alerts automatically upon analyzing a resulting program to allow the user to modify their program.

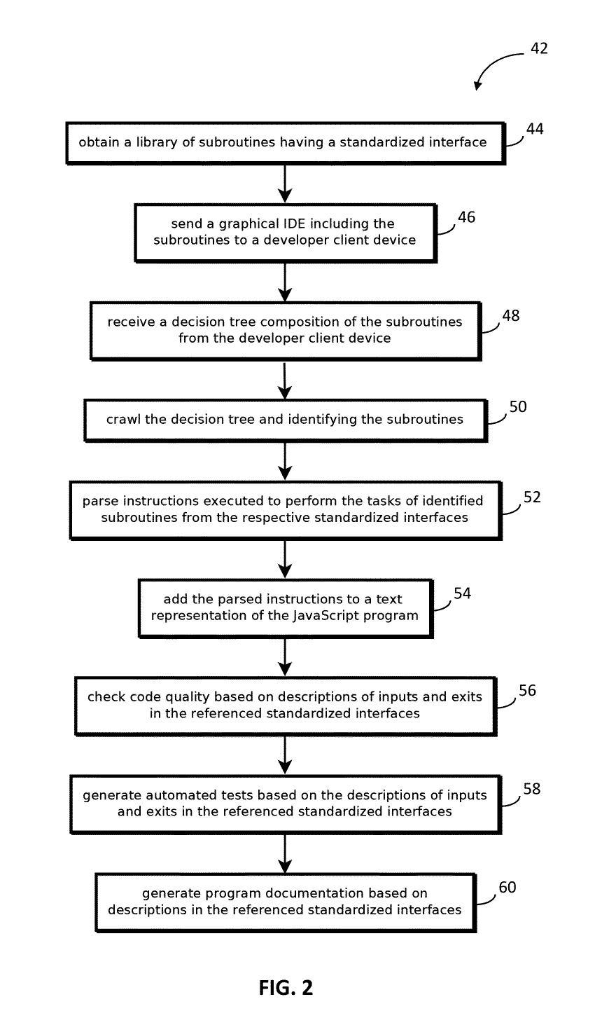

FIG. 2 illustrates an example of a process 42 that may be performed by the metaprogramming platform 12 of FIG. 1. In some embodiments, the process 42 includes obtaining a library of subroutines having a standardized interface, as indicated by block 44, and sending a graphical integrated development environment (IDE) including the subroutines to a developer client device, as indicated by block 46. Examples of this graphical IDE are described below with reference to FIGS. 3 through 5. Next, some embodiments may receive a decision tree composition of the subroutines from the developer client device, as indicated by block 48. In some embodiments, steps 46 and 48 may be performed by the above-described composition interface 22. In some cases, the decision tree may be received via a sequence of adjustments to a ongoing project in an ongoing session with the developer client device, as the developer drags and drops subroutines and connects the subroutines to one another to express the business logic to be performed.

Next, some embodiments may crawl the decision tree and identify the subroutines, as indicated block 50. For example, the decision tree may be called recursively to accommodate a diverse range of decision tree structures. In some embodiments, as the tree is crawled, references subroutines may be detected, and an inventory of links between the subroutines and or various other inputs or outputs, for example, involving third-party APIs, or user inputs or outputs, may be maintained.

Next, some embodiments may parse instructions executed to perform the tasks of identified subroutines from the respective standardized interfaces, as indicated by block 52. Embodiments may add the parsed instructions to a text representation of the JavaScript program being formed, as indicated by block 54. Next, some embodiments may perform code quality checks based on the descriptions of inputs and exits in the reference standardized interfaces, as indicated by block 56. This step may include checking for data type matches and various constraints on the inputs, such as formatting for dates, ranges or types of values expected, confirming required values are provided, and the like. Next, some embodiments may generate automated test programs based on the descriptions of inputs and exits in the references standardized interfaces, as indicated by block 58. In some embodiments, the process 42 may further generate program documentation based on descriptions in the reference standardized interfaces as indicated by block 60. The program documentation may be in human readable prose form suitable for a layperson and based on the descriptions embedded in the standardized interfaces for the subroutines used and their respective inputs and exits referenced.

FIG. 3 illustrates an example of an IDE for visual programming hosted by the composition interface 22 and, for example, displayed in a web browser of developer client device 14. In this example, the interface includes a field 64 in which the user may drag-and-drop subroutines in the repository 26 and displayed in a menu onto the field 64 for use in a program. In this example, five subroutines 66 through 74 are illustrated. Using the graphical user interface 62, the developer may also connect exits of subroutines to inputs of other subroutines for instance connecting exit 76 of subroutine 66 to input 78 of subroutine 68. In this example, subroutine 66 includes a second exit 80 connected to input 82 of subroutine 70. The resulting graph may form a decision tree from which a JavaScript program may be compiled. In some cases, the resulting decision tree may be saved and submitted to the platform 12, which may then compile a JavaScript program and perform the process 42. In some cases, the graph may be an asynchronous graph, and the platform may check for cycles during validation to enforce something closer to a functional programming paradigm and afford the benefits associated therewith (e.g., statelessness, lack of race conditions, and the like). Or some embodiments may accommodate more complex flows. In some cases, subroutines may be composed in a hierarchy, with a composition of subroutines being designated as a subroutine in another program.

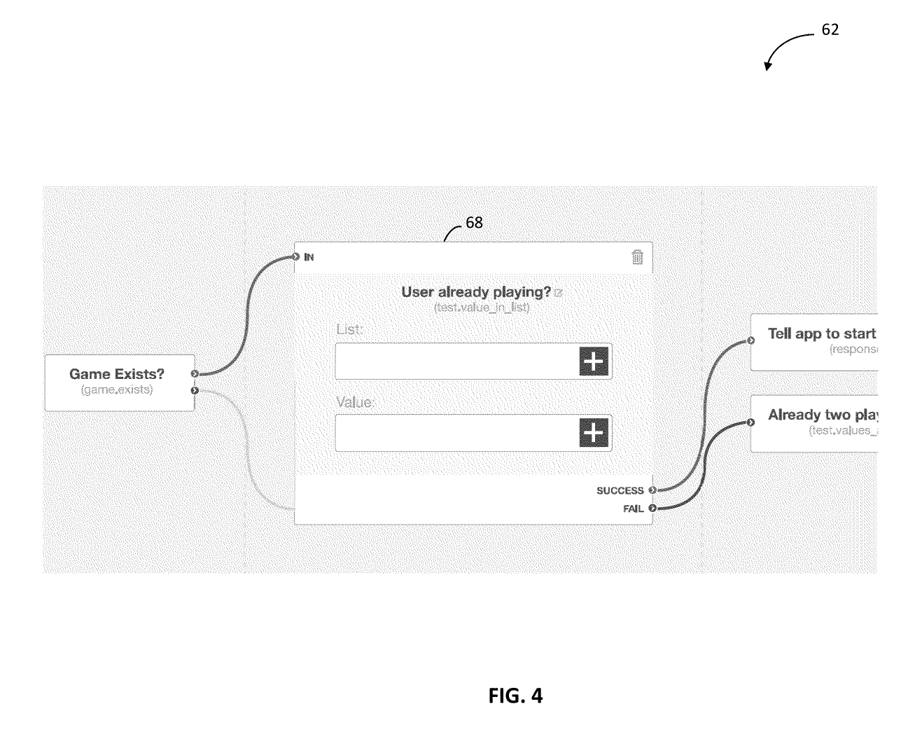

FIG. 4 illustrates the same graphical user interface 62 after the user has selected subroutine 68 to request a more detailed view of the input and the exits. In some embodiments, the graphical user interface may include web forms in which the user supplies additional parameters of the inputs, and this case a list and value parameter.

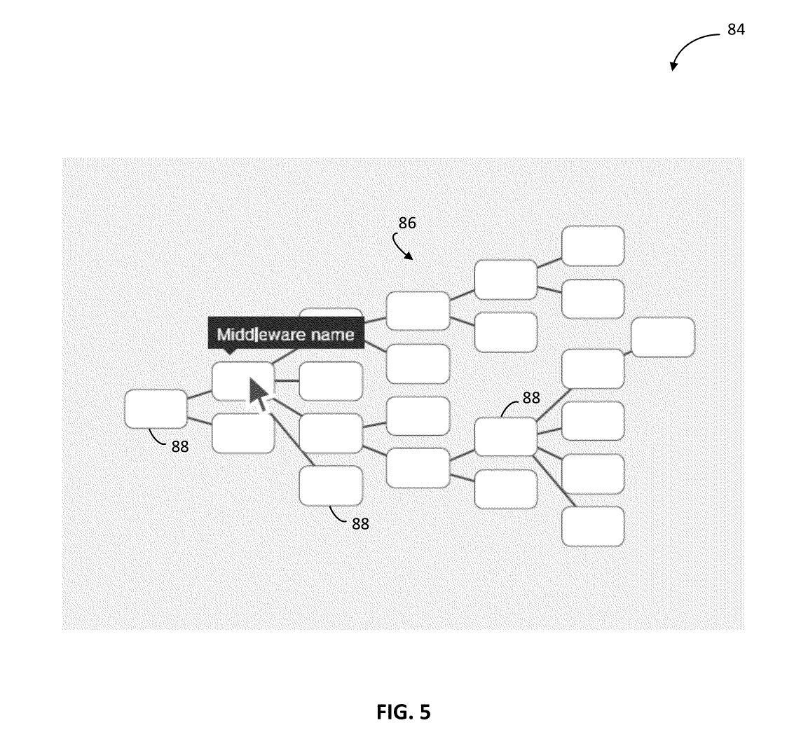

FIG. 5 illustrates a graphical user interface 84 executing on the developer client device 14 and depicting a more complex decision tree 86. In this example, the decision tree 86 composed by a programmer includes a plurality of subroutines 88 having inputs connected to exits of other subroutines as illustrated. It is expected that even relatively complex business logic may be understood and programmed by relatively unsophisticated developers using this graphical arrangement, particularly with the assistance provided by the standardized interfaces of the subroutines. Further, as illustrated, the user may mouse over or drill down into the subroutines to better understand the operation of the program.

FIG. 6 is a diagram that illustrates an exemplary computing system 1000 in accordance with embodiments of the present technique. Various portions of systems and methods described herein, may include or be executed on one or more computer systems similar to computing system 1000. Further, processes and modules described herein may be executed by one or more processing systems similar to that of computing system 1000.

Computing system 1000 may include one or more processors (e.g., processors 1010a-1010n) coupled to system memory 1020, an input/output I/O device interface 1030, and a network interface 1040 via an input/output (I/O) interface 1050. A processor may include a single processor or a plurality of processors (e.g., distributed processors). A processor may be any suitable processor capable of executing or otherwise performing instructions. A processor may include a central processing unit (CPU) that carries out program instructions to perform the arithmetical, logical, and input/output operations of computing system 1000. A processor may execute code (e.g., processor firmware, a protocol stack, a database management system, an operating system, or a combination thereof) that creates an execution environment for program instructions. A processor may include a programmable processor. A processor may include general or special purpose microprocessors. A processor may receive instructions and data from a memory (e.g., system memory 1020). Computing system 1000 may be a uni-processor system including one processor (e.g., processor 1010a), or a multi-processor system including any number of suitable processors (e.g., 1010a-1010n). Multiple processors may be employed to provide for parallel or sequential execution of one or more portions of the techniques described herein. Processes, such as logic flows, described herein may be performed by one or more programmable processors executing one or more computer programs to perform functions by operating on input data and generating corresponding output. Processes described herein may be performed by, and apparatus can also be implemented as, special purpose logic circuitry, e.g., an FPGA (field programmable gate array) or an ASIC (application specific integrated circuit). Computing system 1000 may include a plurality of computing devices (e.g., distributed computer systems) to implement various processing functions.

I/O device interface 1030 may provide an interface for connection of one or more I/O devices 1060 to computer system 1000. I/O devices may include devices that receive input (e.g., from a user) or output information (e.g., to a user). I/O devices 1060 may include, for example, graphical user interface presented on displays (e.g., a cathode ray tube (CRT) or liquid crystal display (LCD) monitor), pointing devices (e.g., a computer mouse or trackball), keyboards, keypads, touchpads, scanning devices, voice recognition devices, gesture recognition devices, printers, audio speakers, microphones, cameras, or the like. I/O devices 1060 may be connected to computer system 1000 through a wired or wireless connection. I/O devices 1060 may be connected to computer system 1000 from a remote location. I/O devices 1060 located on remote computer system, for example, may be connected to computer system 1000 via a network and network interface 1040.

Network interface 1040 may include a network adapter that provides for connection of computer system 1000 to a network. Network interface may 1040 may facilitate data exchange between computer system 1000 and other devices connected to the network. Network interface 1040 may support wired or wireless communication. The network may include an electronic communication network, such as the Internet, a local area network (LAN), a wide area network (WAN), a cellular communications network, or the like.

System memory 1020 may be configured to store program instructions 1100 or data 1110. Program instructions 1100 may be executable by a processor (e.g., one or more of processors 1010a-1010n) to implement one or more embodiments of the present techniques. Instructions 1100 may include modules of computer program instructions for implementing one or more techniques described herein with regard to various processing modules. Program instructions may include a computer program (which in certain forms is known as a program, software, software application, script, or code). A computer program may be written in a programming language, including compiled or interpreted languages, or declarative or procedural languages. A computer program may include a unit suitable for use in a computing environment, including as a stand-alone program, a module, a component, or a subroutine. A computer program may or may not correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may be deployed to be executed on one or more computer processors located locally at one site or distributed across multiple remote sites and interconnected by a communication network.

System memory 1020 may include a tangible program carrier having program instructions stored thereon. A tangible program carrier may include a non-transitory computer readable storage medium. A non-transitory computer readable storage medium may include a machine readable storage device, a machine readable storage substrate, a memory device, or any combination thereof. Non-transitory computer readable storage medium may include non-volatile memory (e.g., flash memory, ROM, PROM, EPROM, EEPROM memory), volatile memory (e.g., random access memory (RAM), static random access memory (SRAM), synchronous dynamic RAM (SDRAM)), bulk storage memory (e.g., CD-ROM and/or DVD-ROM, hard-drives), or the like. System memory 1020 may include a non-transitory computer readable storage medium that may have program instructions stored thereon that are executable by a computer processor (e.g., one or more of processors 1010a-1010n) to cause the subject matter and the functional operations described herein. A memory (e.g., system memory 1020) may include a single memory device and/or a plurality of memory devices (e.g., distributed memory devices). Instructions or other program code to provide the functionality described herein may be stored on a tangible, non-transitory computer readable media. In some cases, the entire set of instructions may be stored concurrently on the media, or in some cases, different parts of the instructions may be stored on the same media at different times, e.g., a copy may be created by writing program code to a first-in-first-out buffer in a network interface, where some of the instructions are pushed out of the buffer before other portions of the instructions are written to the buffer, with all of the instructions residing in memory on the buffer, just not all at the same time.

I/O interface 1050 may be configured to coordinate I/O traffic between processors 1010a-1010n, system memory 1020, network interface 1040, I/O devices 1060, and/or other peripheral devices. I/O interface 1050 may perform protocol, timing, or other data transformations to convert data signals from one component (e.g., system memory 1020) into a format suitable for use by another component (e.g., processors 1010a-1010n). I/O interface 1050 may include support for devices attached through various types of peripheral buses, such as a variant of the Peripheral Component Interconnect (PCI) bus standard or the Universal Serial Bus (USB) standard.

Embodiments of the techniques described herein may be implemented using a single instance of computer system 1000 or multiple computer systems 1000 configured to host different portions or instances of embodiments. Multiple computer systems 1000 may provide for parallel or sequential processing/execution of one or more portions of the techniques described herein.

Those skilled in the art will appreciate that computer system 1000 is merely illustrative and is not intended to limit the scope of the techniques described herein. Computer system 1000 may include any combination of devices or software that may perform or otherwise provide for the performance of the techniques described herein. For example, computer system 1000 may include or be a combination of a cloud-computing system, a data center, a server rack, a server, a virtual server, a desktop computer, a laptop computer, a tablet computer, a server device, a client device, a mobile telephone, a personal digital assistant (PDA), a mobile audio or video player, a game console, a vehicle-mounted computer, or a Global Positioning System (GPS), or the like. Computer system 1000 may also be connected to other devices that are not illustrated, or may operate as a stand-alone system. In addition, the functionality provided by the illustrated components may in some embodiments be combined in fewer components or distributed in additional components. Similarly, in some embodiments, the functionality of some of the illustrated components may not be provided or other additional functionality may be available.

Those skilled in the art will also appreciate that while various items are illustrated as being stored in memory or on storage while being used, these items or portions of them may be transferred between memory and other storage devices for purposes of memory management and data integrity. Alternatively, in other embodiments some or all of the software components may execute in memory on another device and communicate with the illustrated computer system via inter-computer communication. Some or all of the system components or data structures may also be stored (e.g., as instructions or structured data) on a computer-accessible medium or a portable article to be read by an appropriate drive, various examples of which are described above. In some embodiments, instructions stored on a computer-accessible medium separate from computer system 1000 may be transmitted to computer system 1000 via transmission media or signals such as electrical, electromagnetic, or digital signals, conveyed via a communication medium such as a network or a wireless link. Various embodiments may further include receiving, sending, or storing instructions or data implemented in accordance with the foregoing description upon a computer-accessible medium. Accordingly, the present invention may be practiced with other computer system configurations.

In block diagrams, illustrated components are depicted as discrete functional blocks, but embodiments are not limited to systems in which the functionality described herein is organized as illustrated. The functionality provided by each of the components may be provided by software or hardware modules that are differently organized than is presently depicted, for example such software or hardware may be intermingled, conjoined, replicated, broken up, distributed (e.g. within a data center or geographically), or otherwise differently organized. The functionality described herein may be provided by one or more processors of one or more computers executing code stored on a tangible, non-transitory, machine readable medium. In some cases, third party content delivery networks may host some or all of the information conveyed over networks, in which case, to the extent information (e.g., content) is said to be supplied or otherwise provided, the information may provided by sending instructions to retrieve that information from a content delivery network.

The reader should appreciate that the present application describes several inventions. Rather than separating those inventions into multiple isolated patent applications, applicants have grouped these inventions into a single document because their related subject matter lends itself to economies in the application process. But the distinct advantages and aspects of such inventions should not be conflated. In some cases, embodiments address all of the deficiencies noted herein, but it should be understood that the inventions are independently useful, and some embodiments address only a subset of such problems or offer other, unmentioned benefits that will be apparent to those of skill in the art reviewing the present disclosure. Due to costs constraints, some inventions disclosed herein may not be presently claimed and may be claimed in later filings, such as continuation applications or by amending the present claims. Similarly, due to space constraints, neither the Abstract nor the Summary of the Invention sections of the present document should be taken as containing a comprehensive listing of all such inventions or all aspects of such inventions.

It should be understood that the description and the drawings are not intended to limit the invention to the particular form disclosed, but to the contrary, the intention is to cover all modifications, equivalents, and alternatives falling within the spirit and scope of the present invention as defined by the appended claims. Further modifications and alternative embodiments of various aspects of the invention will be apparent to those skilled in the art in view of this description. Accordingly, this description and the drawings are to be construed as illustrative only and are for the purpose of teaching those skilled in the art the general manner of carrying out the invention. It is to be understood that the forms of the invention shown and described herein are to be taken as examples of embodiments. Elements and materials may be substituted for those illustrated and described herein, parts and processes may be reversed or omitted, and certain features of the invention may be utilized independently, all as would be apparent to one skilled in the art after having the benefit of this description of the invention. Changes may be made in the elements described herein without departing from the spirit and scope of the invention as described in the following claims. Headings used herein are for organizational purposes only and are not meant to be used to limit the scope of the description.

As used throughout this application, the word “may” is used in a permissive sense (i.e., meaning having the potential to), rather than the mandatory sense (i.e., meaning must). The words “include”, “including”, and “includes” and the like mean including, but not limited to. As used throughout this application, the singular forms “a,” “an,” and “the” include plural referents unless the content explicitly indicates otherwise. Thus, for example, reference to “an element” or “a element” includes a combination of two or more elements, notwithstanding use of other terms and phrases for one or more elements, such as “one or more.” The term “or” is, unless indicated otherwise, non-exclusive, i.e., encompassing both “and” and “or.” Terms describing conditional relationships, e.g., “in response to X, Y,” “upon X, Y,”, “if X, Y,” “when X, Y,” and the like, encompass causal relationships in which the antecedent is a necessary causal condition, the antecedent is a sufficient causal condition, or the antecedent is a contributory causal condition of the consequent, e.g., “state X occurs upon condition Y obtaining” is generic to “X occurs solely upon Y” and “X occurs upon Y and Z.” Such conditional relationships are not limited to consequences that instantly follow the antecedent obtaining, as some consequences may be delayed, and in conditional statements, antecedents are connected to their consequences, e.g., the antecedent is relevant to the likelihood of the consequent occurring. Statements in which a plurality of attributes or functions are mapped to a plurality of objects (e.g., one or more processors performing steps A, B, C, and D) encompasses both all such attributes or functions being mapped to all such objects and subsets of the attributes or functions being mapped to subsets of the attributes or functions (e.g., both all processors each performing steps A-D, and a case in which processor 1 performs step A, processor 2 performs step B and part of step C, and processor 3 performs part of step C and step D), unless otherwise indicated. Further, unless otherwise indicated, statements that one value or action is “based on” another condition or value encompass both instances in which the condition or value is the sole factor and instances in which the condition or value is one factor among a plurality of factors. Unless otherwise indicated, statements that “each” instance of some collection have some property should not be read to exclude cases where some otherwise identical or similar members of a larger collection do not have the property, i.e., each does not necessarily mean each and every. Limitations as to sequence of recited steps should not be read into the claims unless explicitly specified, e.g., with explicit language like “after performing X, performing Y,” in contrast to statements that might be improperly argued to imply sequence limitations, like “performing X on items, performing Y on the X'ed items,” used for purposes of making claims more readable rather than specifying sequence. Unless specifically stated otherwise, as apparent from the discussion, it is appreciated that throughout this specification discussions utilizing terms such as “processing,” “computing,” “calculating,” “determining” or the like refer to actions or processes of a specific apparatus, such as a special purpose computer or a similar special purpose electronic processing/computing device.

In this patent, certain U.S. patents, U.S. patent applications, or other materials (e.g., articles) have been incorporated by reference. The text of such U.S. patents, U.S. patent applications, and other materials is, however, only incorporated by reference to the extent that no conflict exists between such material and the statements and drawings set forth herein. In the event of such conflict, any such conflicting text in such incorporated by reference U.S. patents, U.S. patent applications, and other materials is specifically not incorporated by reference in this patent.

The present techniques will be better understood with reference to the following enumerated embodiments:

1. A method of compiling user instructions into a JavaScript program, the method comprising: obtaining a library comprising a plurality of subroutines having a standardized interface and encoded in a human-readable format, each subroutine being a callable unit, each standardized interface comprising: a set of input specifications of inputs to the respective subroutine, each input specification comprising: a unique identifier of the respective input specification; a description of the respective input; and an indication of whether the respective input is required by the respective subroutine; a set of exit specifications of exits to the respective subroutine, each exit specification comprising: a unique identifier of the respective exit specification; and a description of the respective exit; one or more instructions executed to perform a task of the respective subroutine, the one or more instructions receiving as input the inputs corresponding to the set of inputs specifications, and the one or more instructions having a set of exits corresponding to the exit specifications; obtaining a decision tree, the decision tree containing a declarative representation of business logic to be implemented in a human-readable JavaScript program to be executed server-side in a client-server architecture, the decision tree identifying at least a plurality of the subroutines in the library to be used in the JavaScript program; and compiling the decision tree and the plurality of subroutines into the JavaScript program, wherein compiling comprises: crawling the decision tree and identifying the subroutines; parsing the one or more instructions executed to perform the tasks of the identified subroutines from the respective standardized interface of the identified subroutines; and adding at least part of the parsed instructions to a text representation of the JavaScript program.
2. The method of embodiment 1, wherein obtaining the decision tree comprises: sending a user device a graphical representation of a block diagram of a portion of the decision tree and at least some of the subroutines in the library; receiving an indication from the user device that the user has dragged and dropped a given one of the subroutines into the block diagram; sending the user device the input specifications and the exit specifications of the given one of the subroutines; and receiving, from the user device, an indication that at least some of the input specifications and at least some of the exit specifications are matched by the user to other input specifications and other exit specifications of other subroutines in the decision tree.
3. The method of any of embodiments 1-2, wherein compiling comprises: composing function calls to subroutines based in links between exits and inputs in the decision tree; and adding the function calls to the text representation of the JavaScript program.
4. The method of any of embodiments 1-3, comprising: automatically generating human-readable, prose-form program documentation based on the set of input specifications or the set of exit specifications.
5. The method of any of embodiments 1-4, wherein at least of the input specifications and at least of the exit specifications comprise a respective data type, the method comprising: crawling the decision tree to identify an exit of a first subroutine mapped to an input of a second subroutine; determining that a data type of the exit of the first subroutine is inconsistent with a data type of the input of the second subroutine; and in response to the determination, alerting a user.
6. The method of any of embodiments 1-5, wherein an input specification of a given subroutine comprises an input validation function, the method comprising: executing the input validation function upon receiving an input to the given subroutine.
7. The method of any of embodiments 1-6, wherein compiling comprises: identifying a given subroutine in the decision tree; determining that the given subroutine contains an input specification with an indication that a respective input is required; determining that the decision tree does not specify a value for the respective input; and in response to the determination, alerting a user.
8. The method of any of embodiments 1-7, wherein a first one of the input specifications comprises a data type that indicates a given input can only be used once, wherein compiling comprises: determining that a second one of the input specifications uses the input; and in response to the determination, alerting a user.
9. The method of any of embodiments 1-8, comprising: generating a test routine for the JavaScript program based on the standardized interface of a subroutine in the JavaScript program.
10. The method of any of embodiments 1-9, comprising: executing the JavaScript routine on in a Node.js server; receiving a request from a browser or native application executing on a remote user device with the server; executing at least three of the subroutines in response to the request; and sending responsive content to the remote user device via the Internet with the Node.js server.
11. A tangible, non-transitory, machine-readable medium storing instructions that when executed by a data processing apparatus cause the data processing apparatus to perform operations comprising: the steps of any of embodiments 1-10.
12. A system, comprising: one or more processors; and memory storing instructions that when executed by the processors cause the processors to effectuate operations comprising: the steps of any of embodiments 1-10.

What is claimed is:

1. A method of compiling user instructions into a JavaScript program, the method comprising:
obtaining a library comprising a plurality of subroutines having a standardized interface and encoded in a human-readable format, each subroutine being a callable unit, each standardized interface comprising:
a set of input specifications of inputs to the respective subroutine, each input specification comprising:
a unique identifier of the respective input specification;
a description of the respective input; and
an indication of whether the respective input is required by the respective subroutine;
a set of exit specifications of exits to the respective subroutine, each exit specification comprising:
a unique identifier of the respective exit specification; and
a description of the respective exit;
one or more instructions executed to perform a task of the respective subroutine, the one or more instructions receiving as input the inputs corresponding to the set of inputs specifications, and the one or more instructions having a set of exits corresponding to the exit specifications;
obtaining a decision tree, the decision tree containing a declarative representation of business logic to be implemented in a human-readable JavaScript program to be executed server-side in a client-server architecture, the decision tree identifying at least a plurality of the subroutines in the library to be used in the JavaScript program; and
compiling the decision tree and the plurality of subroutines into the JavaScript program, wherein compiling comprises:
crawling the decision tree and identifying the subroutines;
parsing the one or more instructions executed to perform the tasks of the identified subroutines from the respective standardized interface of the identified subroutines; and
adding at least part of the parsed instructions to a text representation of the JavaScript program.

2. The method of claim 1, wherein obtaining the decision tree comprises:
sending a user device a graphical representation of a block diagram of a portion of the decision tree and at least some of the subroutines in the library;
receiving an indication from the user device that the user has dragged and dropped a given one of the subroutines into the block diagram;
sending the user device the input specifications and the exit specifications of the given one of the subroutines; and
receiving, from the user device, an indication that at least some of the input specifications and at least some of the exit specifications are matched by the user to other input specifications and other exit specifications of other subroutines in the decision tree.

3. The method of claim 1, wherein compiling comprises:
composing function calls to subroutines based in links between exits and inputs in the decision tree; and
adding the function calls to the text representation of the JavaScript program.

4. The method of claim 1, comprising:
automatically generating human-readable, prose-form program documentation based on the set of input specifications or the set of exit specifications.

5. The method of claim 1, wherein at least of the input specifications and at least of the exit specifications comprise a respective data type, the method comprising:
crawling the decision tree to identify an exit of a first subroutine mapped to an input of a second subroutine;
determining that a data type of the exit of the first subroutine is inconsistent with a data type of the input of the second subroutine; and
in response to the determination, alerting a user.

6. The method of claim 1, wherein an input specification of a given subroutine comprises an input validation function, the method comprising:
executing the input validation function upon receiving an input to the given subroutine.

7. The method of claim 1, wherein compiling comprises:
identifying a given subroutine in the decision tree;
determining that the given subroutine contains an input specification with an indication that a respective input is required;
determining that the decision tree does not specify a value for the respective input; and
in response to the determination, alerting a user.

8. The method of claim 1, wherein a first one of the input specifications comprises a data type that indicates a given input can only be used once, wherein compiling comprises:
determining that a second one of the input specifications uses the input; and
in response to the determination, alerting a user.

9. The method of claim 1, comprising:
generating a test routine for the JavaScript program based on the standardized interface of a subroutine in the JavaScript program.

10. The method of claim 1, comprising:
executing the JavaScript routine on in a Node.js server;
receiving a request from a browser or native application executing on a remote user device with the server;
executing at least three of the subroutines in response to the request; and
sending responsive content to the remote user device via the Internet with the Node.js server.

11. A system comprising:
one or more processors; and
memory storing instructions that when executed by at least some of the processors effectuate operations comprising:
obtaining a library comprising a plurality of subroutines having a standardized interface and encoded in a human-readable format, each subroutine being a callable unit, each standardized interface comprising:
a set of input specifications of inputs to the respective subroutine, each input specification comprising:
a unique identifier of the respective input specification;
a description of the respective input; and
an indication of whether the respective input is required by the respective subroutine;
a set of exit specifications of exits to the respective subroutine, each exit specification comprising:
a unique identifier of the respective exit specification; and
a description of the respective exit;
one or more instructions executed to perform a task of the respective subroutine, the one or more instructions receiving as input the inputs corresponding to the set of inputs specifications, and the one or more instructions having a set of exits corresponding to the exit specifications;
obtaining a decision tree, the decision tree containing a declarative representation of business logic to be implemented in a human-readable JavaScript program to be executed server-side in a client-server architecture, the decision tree identifying at least a plurality of the subroutines in the library to be used in the JavaScript program; and
compiling the decision tree and the plurality of subroutines into the JavaScript program, wherein compiling comprises:
crawling the decision tree and identifying the subroutines;
parsing the one or more instructions executed to perform the tasks of the identified subroutines from the respective standardized interface of the identified subroutines; and
adding at least part of the parsed instructions to a text representation of the JavaScript program.

12. The system of claim 11, wherein obtaining the decision tree comprises:
sending a user device a graphical representation of a block diagram of a portion of the decision tree and at least some of the subroutines in the library;
receiving an indication from the user device that the user has dragged and dropped a given one of the subroutines into the block diagram;
sending the user device the input specifications and the exit specifications of the given one of the subroutines; and
receiving, from the user device, an indication that at least some of the input specifications and at least some of the exit specifications are matched by the user to other input specifications and other exit specifications of other subroutines in the decision tree.

13. The system of claim 11, wherein compiling comprises:
composing function calls to subroutines based in links between exits and inputs in the decision tree; and
adding the function calls to the text representation of the JavaScript program.

14. The system of claim 11, comprising:
automatically generating human-readable, prose-form program documentation based on the set of input specifications or the set of exit specifications.

15. The system of claim 11, wherein at least of the input specifications and at least of the exit specifications comprise a respective data type, the method comprising:
crawling the decision tree to identify an exit of a first subroutine mapped to an input of a second subroutine;
determining that a data type of the exit of the first subroutine is inconsistent with a data type of the input of the second subroutine; and
in response to the determination, alerting a user.

16. The system of claim 11, wherein an input specification of a given subroutine comprises an input validation function, the method comprising:
executing the input validation function upon receiving an input to the given subroutine.

17. The system of claim 11, wherein compiling comprises:
identifying a given subroutine in the decision tree;
determining that the given subroutine contains an input specification with an indication that a respective input is required;
determining that the decision tree does not specify a value for the respective input; and
in response to the determination, alerting a user.

18. The system of claim 11, wherein a first one of the input specifications comprises a data type that indicates a given input can only be used once, wherein compiling comprises:
determining that a second one of the input specifications uses the input; and
in response to the determination, alerting a user.

19. The system of claim 11, comprising:
generating a test routine for the JavaScript program based on the standardized interface of a subroutine in the JavaScript program.

20. The system of claim 11, comprising:
executing the JavaScript routine on in a Node.js server;
receiving a request from a browser or native application executing on a remote user device with the server;
executing at least three of the subroutines in response to the request; and
sending responsive content to the remote user device via the Internet with the Node.js server.
